(19) United States
(12) Patent Application Publication
(10) Pub. No.: US 2024/0289795 A1
(43) Pub. Date: Aug. 29, 2024

(54) AUTOMATED VENDING SERVICES WITH PRE-AUTHORIZATION FROM MOBILE DEVICE

(71) Applicant: FOURTHIQ LLC, Jacksonville, FL (US)

(72) Inventor: Randy Leonard, Broomfield, CO (US)

(21) Appl. No.: 18/174,404

(22) Filed: Feb. 24, 2023

(51) Int. Cl. G06Q 20/40; G06Q 20/18; G06Q 20/32; G06Q 20/38

(52) U.S. Cl. CPC G06Q 20/4014; G06Q 20/18; G06Q 20/325; G06Q 20/38215; G06Q 2220/00

(57) ABSTRACT

Methods, systems, and apparatus, including computer programs encoded on a computer storage medium, for broadcasting an availability message indicating characteristics of a vending machine. Receiving, from a device, a vend message including pre-authorization information and a certificate indicating a time period since the certificate was synchronized with a server. Sending a signal to the vending machine to enable one or more user controls of the vending machine and initiate a vend process. Receiving a request from the vending machine to provide a service or product. Determining whether to approve a transaction based on the pre-authorization information. Sending a validation message and a vending identification to the mobile computing device, where the vending identification is usable by the mobile computing device to secure future communications between the transceiver unit and the mobile computing device until completion of the vend process.

### TECHNICAL FIELD

The present disclosure generally relates the operation of vending machines and other automated service machines.

### BACKGROUND

Traditionally, commercial laundry businesses such as laundromats operate as cash-only businesses in which patrons use coins or tokens to feed into washers or dryers. This business model is not user-friendly, given the potentially large number of coins or tokens that may be required to enable a customer to wash and dry one or more loads of laundry. More recently, some laundromats have allowed users to pay for laundry services using a credit card or online payment systems. Such methods often, however, depend on the user having an internet connection at the time the services are requested (e.g., to make payment or to authorize payment for the services).

### SUMMARY

Implementations of the present disclosure are generally directed to managing and controlling vending machines to provide services. Some implementations are directed to controlling laundry machine(s) through the use of remote signals.

In general, innovative aspects of the subject matter described in this specification can be embodied in methods that include the actions of broadcasting, by a transceiver unit coupled to a vending machine, an availability message indicating an identity of the vending machine, a type of the vending machine, and a status of the vending machine. Receiving, from a mobile computing device, by way of one or more wireless signals, a vend message including pre-authorization information and a certificate indicating a time period since the certificate was synchronized with a server. Sending a signal to the vending machine to enable one or more user controls of the vending machine and initiate a vend process. Receiving a request from the vending machine to provide a service or product. Determining whether to approve a transaction based on the pre-authorization information. Sending a validation message and a vending identification to the mobile computing device, where the vending identification is usable by the mobile computing device to secure future communications between the transceiver unit and the mobile computing device until completion of the vend process. Sending an updated availability message indicating the status of the vending machine as being in use. Other implementations of this aspect include corresponding systems, apparatus, and computer programs, configured to perform the actions of the methods, encoded on computer storage devices. These and other implementations can each optionally include one or more of the following features.

In some implementations, the vend message is received via a Bluetooth Low Energy (BLE) signal.

Some implementations include sending, to the mobile computing device, a purchase price for the transaction, and modifying, by the mobile computing device, the pre-authorization information to account for the purchase price for the transaction.

In some implementations, the pre-authorization information includes a pre-authorization amount, and determining whether to approve the transaction includes determining whether a purchase price for the transaction is within the pre-authorization amount.

In some implementations, determining whether to approve the transaction includes determining that the certificate is valid.

In some implementations, determining that the certificate is valid includes determining that the time period is less than a validation time period.

In some implementations, the pre-authorization information includes a stored value balance.

In some implementations, the pre-authorization information includes a stored value balance received by the mobile computing device from a server over a network, and the vend message is received while the mobile computing device is not connected to the server.

In some implementations, the pre-authorization information includes a tender type.

In some implementations, sending the signal to the vending machine to enable one or more user controls of the vending machine includes emulating a signal of a payment processing device.

In some implementations, sending the signal to the vending machine to enable one or more user controls of the vending machine includes emulating a signal of a credit card reader.

Some implementations include receiving, from the mobile computing device, a request for status information about the vending machine, the request includes a session identifier derived from the vending identification, and sending, to the mobile computing device, in response to the request, status information about the vending machine. In some implementations, the status information includes time remaining of an operation of the vending machine. In some implementations, the status information includes availability of the vending machine.

Some implementations include storing, in a memory, dynamic pricing information for transactions to be fulfilled by the vending machine, and determining, based on the dynamic pricing information, a purchase price for at least one transaction to be fulfilled by the vending machine.

In some implementations, the vending machine is a laundry machine.

In some implementations, the pre-authorization information allows aggregation of payment for two or more transactions to be performed by one of the vending machine.

In some implementations, the vend message is received via a Bluetooth Low Energy (BLE) signal via a hub coupled to two or more mobile computing devices or two or more vending machines.

Some implementations include displaying, by the vending machine, a price to a user of the vending machine.

In some implementations, the availability message is an eight character message including two or more characters representing the identity of the vending machine, one character representing the type of the vending machine, and one character representing the status of the vending machine.

Another general aspect can be embodied in a methods that include the actions of receiving, by a mobile device and from a transceiver coupled to a vending machine, an availability message indicating an identity of the vending machine, a type of the vending machine, and a status of the vending machine. In response to receiving user input requesting to initiate a vending transaction with the vending machine, sending, by way of one or more wireless signals to the transceiver, a vend message including the pre-authorization information and a certificate indicating a time period since the certificate was synchronized with a server. Receiving a validation message from the transceiver indicating a purchase price for the vending transaction. Sending a payment confirmation message to the transceiver. Updating the pre-authorization information based on the purchase price of the vend transaction. Other implementations of this aspect include corresponding systems, apparatus, and computer programs, configured to perform the actions of the methods, encoded on computer storage devices. These and other implementations can each optionally include one or more of the following features.

In some implementations, the vend message is sent via a Bluetooth Low Energy (BLE) signal.

Some implementations include detecting an network connection; and synchronizing the pre-authorization information with the server.

In some implementations, the vend message is sent from the mobile computing device while the mobile computing device does not have a network connection to the server.

Some implementations include determining whether the pre-authorization information was last synchronized within an acceptable time limit.

In some implementations, the certificate is stored on the mobile computing device in a secure element.

In some implementations, at least a portion of the pre-authorization information is stored on the mobile computing device in a secure element.

Some implementations include establishing a secure connection between the mobile computing device and the vending machine by deriving a session identifier from the vending identification and sending the session identifier to the transceiver with a request.

Some implementations include sending to the vending machine, from the mobile computing device, a request for status information about the vending machine, where the request includes a session identifier derived from the vending identification, and receiving, by the mobile computing device, from the vending machine, in response to the request, status information about the vending machine.

In some implementations, the pre-authorization information includes a pre-authorization amount, and determining whether to approve the transaction includes determining whether a purchase price for the transaction is within the pre-authorization amount.

In some implementations, the pre-authorization information includes a stored value balance.

In some implementations, the pre-authorization information includes a tender type.

In some implementations, sending the control signal to the vending machine includes sending a signal to a payment processing device of the vending machine.

Some implementations include coupling a fob to a credit card reader of the vending machine, where sending the control signal to the vending machine includes sending a signal to the credit card reader.

In some implementations, the vending machine includes a laundry machine.

In some implementations, the pre-authorization information allows aggregation of payment for two or more transactions on the same vending machine.

In some implementations, the vend message is sent via a Bluetooth Low Energy (BLE) signal via a hub coupled with two or more vending machines.

Implementations of the present disclosure may provide one or more of the following advantages: Implementations of the present disclosure allow users to make payment for and receive services from unattended vending machines using a mobile device even when an internet connection is not available. In particular, implementations, provide solutions the technical problem that often arises in mobile payment platforms of making or authorizing a payment to an unattended payment platform when the user device (e.g., smartphone), the payment platform, or both lack internet connectivity. Implementations of the present disclosure may mitigate a risk of fraud or misuse of payment systems to obtain services without paying for them. Implementations of the present disclosure reduce wireless signal interference between devices and facilities having many active user mobile devices and network-enabled vending machines.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system for providing a vending service in accordance with implementations of the present disclosure.

FIG. 2 depicts an example process flow for a process within the example system of FIG. 1.

FIG. 3 depicts an example system for providing a service or product from a vending machine in accordance with implementations such as those of the present disclosure.

FIG. 4 depicts an example of a process for using a vending machine that may be executed in accordance with implementations such as those of the present disclosure.

FIG. 5 depicts an example of extending a previously started vend process that may be executed in accordance with implementations such as those of the present disclosure.

FIG. 6 depicts an example of vend process that includes a mobile device claiming a vending machine service by providing a cycle ID.

FIG. 7 depicts an example of a process including pre-transaction transfer of payment and pricing information from a management platform server that may be executed in accordance with implementations such as those of the present disclosure.

FIG. 8 depicts an example of a process for validating credentials for a transaction from a vending machine that may be executed in accordance with implementations such as those of the present disclosure.

FIG. 9 depicts an example of a system including a hub for conveying signals between mobile devices and vending machines.

FIG. 10 depicts an example computing system architecture in accordance with implementations of the present disclosure.

### DETAILED DESCRIPTION

The present disclosure describes implementations for providing services from vending machines and other systems that provide for unattended payments. Examples of systems with unattended payment platforms include laundry machines, electric vehicle (EV) charging stations, gas pumps, food and beverage vending machines, car washes, parking access or permission systems (for example, meters, parking kiosks, or gates), ticket kiosks (for example, transportation, theater, entertainment), retail kiosks (for example, personal electronics).

In some implementations, a user of a vending machine may still be enabled to use the vending machine even when the user's mobile device, the vending machine, or both, are offline without access to a network. Payment processing, accounting operations, or other actions can be performed later when the user device or vending machine regain network access. In this way, implementations may enable customers to receive services during network outages or in locations with poor cellular or WiFi service.

In some implementations, a mobile device of a user serves as a trusted point of authentication for ensuring payment by the user for services from vending machines even when the mobile device is offline.

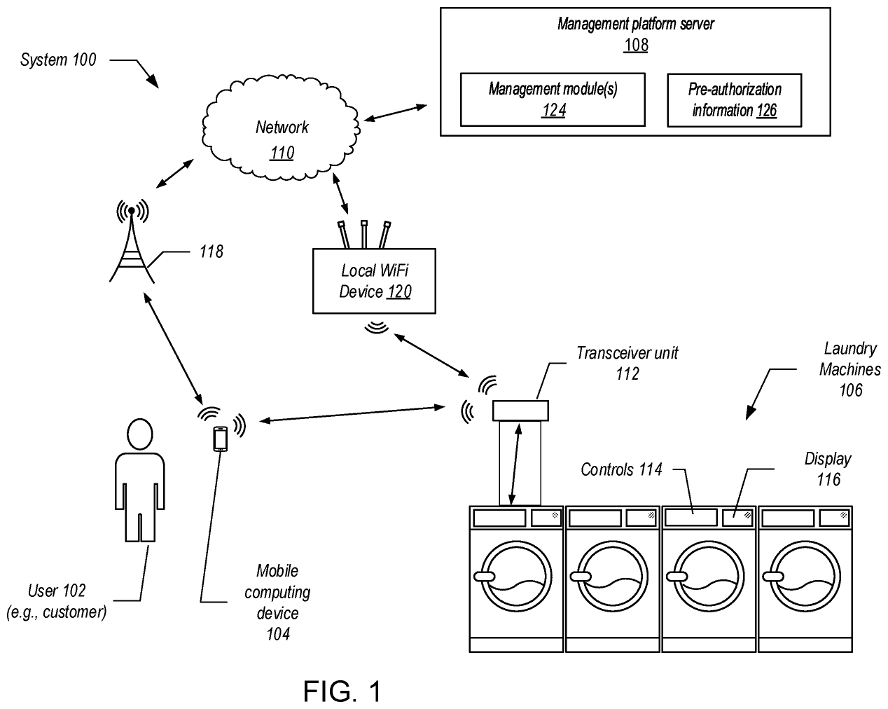

FIG. 1 depicts an example system 100 for providing a vending service in accordance with implementations such as those of the present disclosure. System 100 is described within the exemplary context of providing laundry services, however, the components and operations of system 100 can be applied to other vending services provided by other unattended payment platforms. System 100 allows a user 102 with mobile device 104 to receive services from laundry machines 106. Mobile device 104 and laundry machines 106 are coupled to management platform server 108 by way of network 110.

User 102 can be a customer of services from laundry machines 106. User 102 and mobile device 104 can be at or near a laundromat or other laundry facility.

Each of laundry machines 106 can be coupled to a transceiver unit 112. Transceiver unit 112 can exchange signals and information with mobile device 104. Transceiver unit 112 and mobile device 104 can exchange signals and information with management platform server 108 over network 110. In the example shown in FIG. 1, mobile device 104 exchanges information with management platform server 108 by way of cellular communication system 118. Transceiver unit 112 can exchange information with management platform server 108 by way of a local wireless device 120 (e.g., a property manager wireless device). In some implementations, local wireless device 120 is a WiFi device, e.g., a WiFi base station or computing device (e.g., a micro-server) coupled to a WiFi base station that is co-located with the laundry machines 106.

Each of laundry machines 106 includes controls 114 and display 116. Controls 114 can be operated by manual operations performed by user 102, via signals from transceiver unit 112, or both. Display 116 displays information to user 102. Display 116 can include one or more status indicators. Examples of display 116 include an LCD display, one or more individual LED indicators, a display screen, or combinations thereof.

Management platform server 108 includes management module(s) 124. Pre-authorization information 126 for users (including user 102) can be stored in a storage device included in, or coupled to, management platform server 108.

Pre-authorization information 126 for user 102 can be synchronized between management platform server 108 and mobile device 104. As will be further described below, user 102 can receive automated services from laundry machines 106 based on pre-authorization information provided from mobile device 104.

Management platform server 108 may generate and provide content that is presented in a user interface (UI) on mobile computing device 104. For example, the management server device(s) may communicate information to a user device, and such information may be presented within a customer application (e.g., a mobile app) executing on the user device. The customer application may enable a user to create a user account with the laundry service. The user may login to the laundry service, using the UI of the customer application, and request availability information describing one or more laundry machines (e.g., washers, dryers, and so forth) that are currently available for use at one or more laundromat facilities. The availability information may also indicate machine(s) which are currently unavailable, e.g., in use or reserved for use. In certain implementations, the availability information may indicate currently available laundry machine(s) in proximity to the current location of the user, such as within a predetermined threshold distance (e.g., 10 miles) of the user's current location or the current location of the user device. The availability information may be presented in the UI of the customer application, in a map and/or other suitable UI element that indicates the locations of the laundromat(s) with currently available laundry machine(s).

In some implementations, the user may specify one or more payment method(s) through the customer application. The payment method(s) may include, but are not limited to, one or more of: stored value account, a credit card, a bank account, a phone service account, a cryptographic currency account (e.g., bitcoin), or an online payment processing service account (e.g., PayPal™). In exchange for use of the laundry machine(s), payment may be authorized to be made to the laundry service using the specified payment method(s).

The laundromat may include any number of laundry machines 106, such as washers and dryers. In some implementations, each laundry machine 106 may be configured to include a status indicator that indicates a current status of the laundry machine. The status indicator can be provided on display 116. In some implementations, the status indicator may indicate one of a plurality of statuses. Example statuses can include in use, reserved, or free. Implementations also support the use of more or fewer possible statuses for laundry machines. A status indicator may indicate that the laundry machine is in use, and currently being used to wash or dry laundry. A status indicator may indicate that the laundry machine is reserved, based on a previous reservation request from a user. A status indicator may indicate that the laundry machine is free, such that a user may employ the laundry machine for doing laundry. As used herein, a free status may indicate that a laundry machine is available.

The user may select to use one or more laundry machines in the laundromat for which the status indicator(s) indicate a status of free, reserved, and/or otherwise available for use by the user. Each of laundry machines 106 can be coupled to, or include, a transceiver unit 112. In some cases, the transceiver may be configured to emit a signal that conforms to a version of a wireless communication protocol. Example wireless communication protocols can include Bluetooth™, Bluetooth Low Energy™, a field communication (NFC) protocol, other radio frequency (RF) communications protocols, and so forth. The signal may include an identifier of the particular laundry machine that emitted the signal. The user may select a laundry machine 106 to use by moving the user device into proximity with the transceiver of the laundry machine.

The wireless network interface of the user device 104 may be a RF receiver, transmitter, and/or transceiver that is configured to receive and/or send communications over a wireless network using any suitable wireless communication protocol.

Although examples herein may describe using RF communications to determine proximity of the user device to the laundry machine, other techniques may also be employed. In some implementations, the machine may emit some other type of signals such as an optical (e.g., visible light) indicator, infrared beacon, sound, and so forth. The user device may detect the emitted signal and, based on detecting the signal, may determine that the user device is in proximity to the laundry machine.

System 100 may operate with respect to a laundromat. The laundromat may include any number of laundry machines 106. In the example shown, the laundromat includes laundry machines 106. For illustrative purposes, laundry machines 106 are shown as washers. Laundry machines 106 can also include dryers. Implementations may operate with respect to laundromats that include washers but no dryers, or that include dryers but no washers. The laundromat may also include other types of laundry machines 106, without limitation.

User 102 may carry a computing device such as mobile device 104. The mobile device 104 may be any type of computing device, including but not limited to a smartphone, tablet computer, laptop computer, electronic book reader, wearable computer (e.g., watch, glasses, etc.), implanted computer, vehicle computer (e.g., automotive computer), and so forth. The mobile device 104 may execute a customer application that is configured to interact with management server device(s) that manage the laundry service.

In some cases, prior to visiting the laundromat, the user 102 may have employed the customer application on the mobile device 104 to sign up as a customer of the laundry service. In some cases, the user 102 may have employed a different application (e.g., executing on a desktop computer) to sign up as a customer of the laundry service. The user 102 may have logged into the laundry service, using the customer application executing on the mobile device 104, prior to approaching the doors of the laundromat.

In cases where the user 102 intends for payment to be made from a stored value account, the user may use the customer application to add value to the user's stored value balance. The user's stored value balance can be maintained on management platform server 108 and mobile device 104, with the devices being periodically synchronized with one another over network 110.

In some implementations, on reaching the laundromat, the user 102 may employ the customer application executing on the mobile device 104 to receive services from laundry machines 106. For example, the laundromat may include a signal, e.g., from a transceiver device 112, arranged in proximity to the doors of the laundromat. In some implementations, the signal may comply with a wireless communication protocol. Example wireless communication protocols can include any appropriate version of the Bluetooth™ wireless technology standard managed by the Bluetooth Special Interest Group (SIG) and previously standardized by the Institute of Electrical and Electronics Engineers (IEEE) in IEEE 802.15.1. In some implementations, the signal may comply with any appropriate version of the Bluetooth Low Energy™ standard managed by the Bluetooth SIG. Bluetooth Low Energy™, marketed as Bluetooth Smart™, enables communications over a similar range as Bluetooth™ but with lower power consumption. Both the Bluetooth™ and Bluetooth Low Energy™ standards are described in versions 4.0 and later of the Bluetooth Core Specification promulgated by the Bluetooth SIG. Implementations also support the use of any NFC protocol, or other wireless communication protocols for the signal. As described above, implementations may employ other types of signals, such as visible light signals, infrared signals, and so forth. Implementations may also employ optical methods of proximity detection such as a numeric and/or alphanumeric code affixed to the machine, a scannable (e.g., QR) code, and so forth, as described above.

Mobile device 104 may be in network connection with management platform server 108 executing management module(s) 124. Management platform server 108 may be physically located at the laundromat, or may be at a location that is geographically remote from the laundromat.

As illustrated in FIG. 1, the laundromat may include any number of laundry machines 106 such as washers and dryers. In some implementations, one or more of the laundry machines 106 may include a status indicator indicating a current status of the laundry machine 106, such as whether the laundry machine 106 is free, in use, or reserved. In some implementations, the status indicator may indicate status using a visible mechanism. For example, the status indicator may include a light-emitting diode (LED) such as a multi-color LED. The LED may emit different colors of light corresponding to possible statuses. For example, the LED may emit green light to indicate that the laundry machine 106 is free, red light to indicate that a laundry machine is in use, and blue light to indicate that the laundry machine 106 is reserved. Implementations also support the use of other types of status indicators, such as status indicators that visually indicate status using displayed symbols, words, and so forth. In some cases, a status indicator may include a mechanism such that different positions or movements of the mechanism may indicate different statuses. Implementations also support the use of status indicators that indicate status using non-visual methods. For example, a status indicator may emit different audible sounds to indicate different statuses. As another example, a status indicator may perform different vibrations, motions, or other haptic outputs to indicate different statuses.

Based on the indicated statuses of the various laundry machines 106, the user 102 may select one or more laundry machines 106 to use (e.g., to vend). The user's selection of laundry machine(s) 106 for use may be based, at least in part, on whether the user 102 previously requested a reservation of laundry machine(s) 106. In some implementations, the customer application executing on the user device 104 may present information describing the location(s) of available laundry machine(s) 106 in the laundromat. Such information may be presented in a schematic or map of the laundromat, or any other type of way-finding information.

In some implementations, a transceiver unit 112 is provided for each of laundry machine(s) 106. In other implementations, a transceiver unit 112 can be coupled to two or more of laundry machine(s) 106.

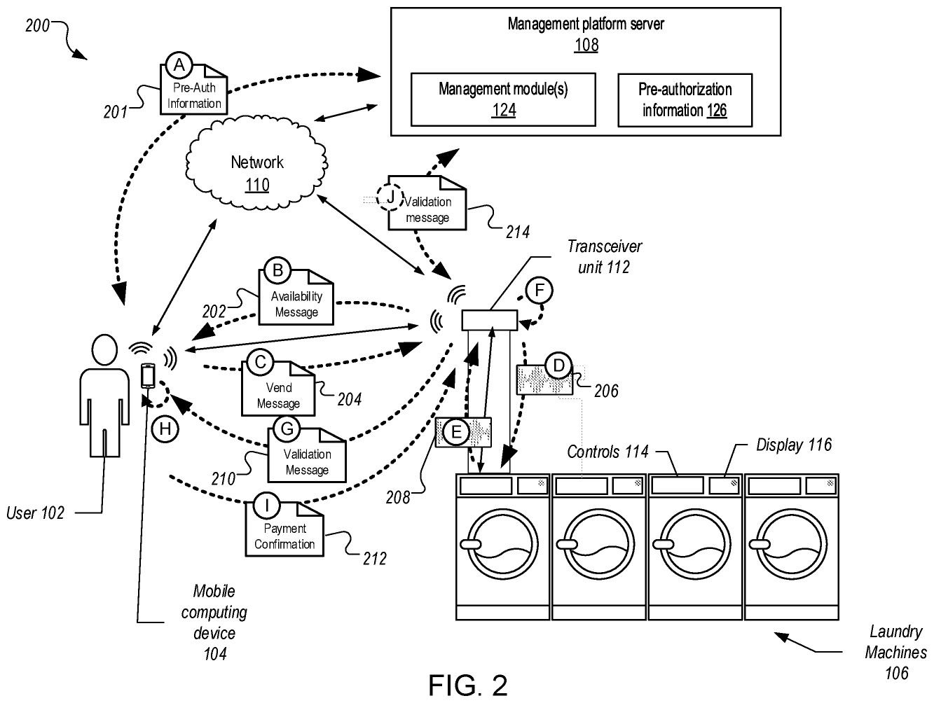

FIG. 2 depicts an example process flow for a process 200 within the example system 100. The process 200 illustrated in FIG. 2 depicts an example process 200 performed by system 100. In this example, pre-authorization information for user 102 is synchronized between management platform server 108 and mobile device 104 before user 102 acquires the services. The synchronization can occur while the user is at the laundry facility or at an earlier time when the mobile device 104 has connectivity with management server 108.

When user 102 initiates vending from laundry machines 106, mobile device 104 may or may not have a network connection with management server device 108. System 100 can use pre-authorization information stored on mobile device 104 and previously synchronized from management platform server 108 to enable services to be provided from laundry machines 106. In some implementations, the pre-authorization information includes a stored value balance for the user 102. The stored value balance can be, but is not limited to, a last available balance on a stored value account or a credit card pre-authorization value as of the most recent synchronization with management platform server 108. In some implementations, pre-authorization information is stored in a secure element in mobile device 104.

In some implementations, pre-authorization information includes a stored value balance. The stored value balance is used as a limit for the value of transactions that can be approved during a period when the mobile device does not have a network connection with the management server 108.

In other implementations, pre-authorization information includes other values or criteria limiting what transactions will be approved. Pre-authorization information may indicate a maximum dollar amount, a maximum number of transactions, or other limit on transactions that can be approved during a period when the mobile device does not have a network connection. For example, a limit can be placed on the number credit card transactions for laundry services approved while the mobile device does not have a network connection.

In certain implementations, transactions may not be allowed unless the mobile device 104 has been synchronized with the management platform server 108 within a prescribed time period (for example, 1 hour, 6 hours, or 24 hours).

In more detail, during state (A), a network connection can be detected between mobile device 104 and management platform service device 108. Pre-authorization information 201 associated with user 102 is synchronized between mobile device 104 and management platform server 108. In some implementations, pre-authorization information is a balance of a stored value account for the user. The stored value balance reflects a value the last synchronization with the management platform server, as well as adjustments for any subsequent purchases by the user since the last synchronization. Stored value information can be stored in a secure element on mobile device 104.

In some implementations, pre-authorization information 201 includes a tender type. Examples of tender type include: stored value, credit card, or Venmo™, or campus card. Different facilities and vending machines may allow transactions using all, or only some, of the available tender types.

During state (B), transceiver unit 112 broadcasts an availability message 202, which is received by mobile device 104. For each laundry machine 106 to which the transceiver unit 112 is coupled, availability message 202 includes the identity of the vending machine, the type of vending machine, and a status of the vending machine.

During state (C), user 102 may review the information from the availability message. If a laundry machine 106 is available, the user may decide to use the laundry machine. In this case, mobile device 104 sends a vend message 204 to transceiver unit 112. The vend message 204 includes the pre-authorization information and a certificate indicating a time period since the certificate was synchronized with the management platform server device 108.

Upon receiving vend message 204, transceiver unit 112 can determine whether the credentials received from mobile device 104 are valid and unexpired. For example, the transceiver unit 112 may determine that a certificate from the mobile device 104 is valid.

Determining that a certificate is valid can include determining whether the time period is less than a validation time period.

During state (D), in response to determining that the credentials received from mobile device 104 are valid and unexpired, transceiver unit 112 sends a signal 206 to the vending machine to enable one or more user controls of the laundry machine 106 and initiate a vend process.

In some implementations, transceiver unit 112 is coupled to an interface port for a payment processing device (such as a credit card reader) for laundry machine 106.

The signal or message(s) sent to the laundry machine may be the same as those that would be received by the credit card reader if a credit card were inserted in the credit card reader.

Once the buttons on laundry machine 106 are enabled, a user can make selections for operating the laundry machine. For example, the user may enter the time of the cycle, whether the cycle is heavy-duty, or other options. During state (E), laundry machine 106 sends a signal 208 indicating a request to start the laundry machine.

During state (F), transceiver unit 112 determines whether the services that have been requested for start are within the pre-authorization limit. For example, if the user had a stored value balance of $28.00 and receives services with a purchase price of $6.00, the transceiver unit 112 will determine that there is a sufficient stored value balance and proceed with the transaction. If the services that have been requested for start are not within the pre-authorization limit, the transceiver unit 112 declines to proceed with the transaction.

During state (G), in the case where the services that have been requested for start are within the pre-authorization limit, transceiver unit 112 sends a validation message 210 with a vend identification to mobile device 104. The vend identification is usable by mobile device 104 to secure future communications between transceiver unit 112 and mobile device 104 until completion of the vend process. Transceiver unit 112 sends the purchase amount for the requested transaction to mobile device 104.

During state (H), on mobile device 104, the pre-authorization information can be updated to reflect the purchase price of the transaction. For example, if the user had a stored value balance of $28.00 and receives services with a purchase price of $6.00, the user's stored account balance on mobile device 104 can be updated to reflect a stored account balance of $22.00. The update to the stored value balance on the mobile device 104 can be performed whether or not the mobile device 104 has a network connection with management platform server 108.

During state (I), mobile device 104 sends a payment confirmation message 212 to transceiver unit 112. In response to receiving payment confirmation message 212, transceiver unit 112 can send a message to laundry machine 106 to cause laundry machine 106 to perform the requested laundry services.

Transceiver unit 112 can send updated availability messages to the mobile device 104. For example, transceiver unit 112 can provide a message to mobile device 104 indicating that the cycle on the selected laundry machine is in-process. Once the laundry machine 106 has performed the services, transceiver unit 112 sends a vend complete message to mobile device 104.

When mobile device 104 has a network connection with management platform server 108, the stored value balance can be synchronized so that management platform server 108 reflects the proper stored account balance. In some implementations, the purchase amount for the transaction is included in the vend complete message.

In some implementations, some or all of the messages between transceiver unit 112 and mobile device 104 are sent using Bluetooth Low Energy (BLE) signals.

In some implementations, information is exchanged directly between management platform server 108 and transceiver unit 112 (for example, over a wireless connection such as property manager wireless device 120 described with respect to FIG.

1). For example, during state (J), management platform server 108 and transceiver unit 112 can exchange validation messages 214 to validate credentials received from mobile device 104. As another example, management platform server 108 can provide dynamic pricing information for services to be performed on laundry machines 106. Messages can be exchanged between management platform server 108 and transceiver unit 112 before, during, or after services are performed by one of laundry machines 106.

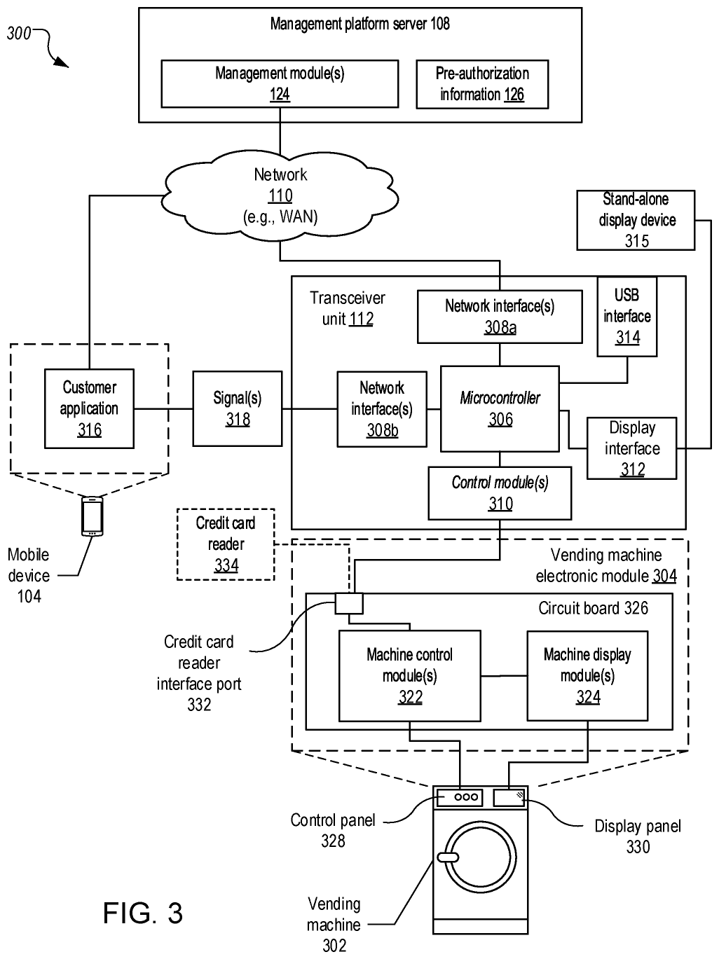

FIG. 3 depicts an example system for providing a service or product from a vending machine in accordance with implementations such as those of the present disclosure. System 300 includes mobile device(s) 104, transceiver unit(s) 112, management platform server 108, and vending machine(s) 302 (for clarity, only one of transceiver unit 112, mobile device 104, and vending machine(s) 302 are shown in FIG. 3). For illustrative purposes, vending machine 302 is depicted as a washing machine in

FIG. 3.

In the example depicted in FIG. 3, mobile device 104 and transceiver unit 112 each have a network connection with management platform server 108 by way of network 110. Mobile device 104 can also exchange messages directly with transceiver unit 112 by way of a wireless connection. In some implementations, mobile device 104 exchanges messages with transceiver unit 112 by way of a Bluetooth Low Energy (BLE) wireless connection. As discussed above, implementations of the present disclosure provide for vending authorization by the mobile device 104 both when the mobile device has a network connection with management platform server 108 and when it does not.

Transceiver unit 112 can broadcast messages that are received by mobile device 104, such as status advertisements. As used herein, “status advertisements” may describe messages that provide status information about a vending machine. For example, status advertisements may provide status information for laundry machines 106, such as whether the machine is available or in-use.

In some implementations, a status advertisement is implemented by way of a

GATT server. Unique identifications can be provided for each advertising signal. In some cases, messages broadcast by transceiver unit 112 are received by all of the users having mobile devices 104 in proximity to transceiver unit 112.

In some implementations, transceiver unit 112 is in the form of a fob. The fob may include one or more plugs, sockets, pigtails, or other features for making a physical and/or wired connection between transceiver unit 112 and other devices of system 300. As will be further described below, the fob may be installed in, or coupled to, an interface port on vending machine 302.

Transceiver unit 112 includes a microcontroller 306, one or more network interfaces 308, and one or more control module(s) 310. In this example, transceiver unit 112 also includes display interface 312 and USB interface 314.

Display interface 312 of transceiver unit 112 may provide an interface an external display device 315, such as an LED display device. USB interface 314 may provide an interface connection for maintenance personnel (for example, to perform diagnostics on transceiver unit 112 or vending machine(s) 302 coupled to the transceiver unit 112. In some implementations control module(s) 310 can control and monitor operations or conditions of the vending machine 302.

Microcontroller 306 may be electronically and communicatively coupled to the network interface(s) 308, the control module(s) 310, such that information may communicated between the microcontroller 306 and the other components. In some implementations, the microcontroller 306 may include one or more integrated circuits (ICs) such as a system-on-a-chip (SoC) or a system in package (SiP) (e.g., multiple chips). In some implementations, transceiver unit 112 is incorporated into the vending machine 302 to enable the laundry machine 302 to operate services as described herein.

The network interface(s) 308 may include hardware component(s) such as any type of network interface controller (NIC) or transceiver configured to enable the microcontroller 306 to communicate with other devices or components over one or more networks 110. The network interface(s) 308 may also include software component(s) such as network protocol stacks, network interface drivers, and so forth. In the example of FIG. 3, the network interface(s) 308 include one or more network interfaces 308a and one or more network interfaces 308b. The network interface(s) 308a may be configured to enable communication over a WAN such as the internet. The network interface(s) 308b may be configured to enable communication over a LAN. In some implementations, the network interface(s) 308b may enable communication over a wireless LAN (WLAN) using a communication protocol that complies with a version of Bluetooth™ or Bluetooth Low Energy™. Some implementations may support the use of other wireless communication protocols such as any NFC protocol.

Mobile device 104 may be a user device operated by a current or potential customer of the service. The mobile device 104 may be any type of computing device, including but not limited to a tablet computer, a notebook computer, or a smartphone. In some implementations, the mobile device 104 or other user device may execute a customer application 316. The customer application 316 may be written or otherwise described using any programming language. In some cases, the customer application 316 may be a native application that is compiled, linked, or otherwise built from source code to generate machine-executable binary instructions configured to execute on the processor(s) and within the operating system (OS) of a computing device such as the mobile device 104. In some cases, the customer application 316 may be written in a programming language that compiles to an intermediate language (e.g., bytecodes) that is executable within a runtime application such as a Java™ Virtual Machine (JVM), C#™ runtime, or any other runtime, interpreter, virtual machine, or execution engine running on a computing device. In some cases, the customer application 316 may include any number of executable instructions in a scripting language or interpreted language, such as JavaScript™, ActiveScript™, VBScript™, Perl™, and so forth. In such cases, the customer application 316 may execute within a runtime, interpreter, virtual machine, scripting engine, or other execution container.

In some cases, the customer application 316 may be configured to execute, at least partly, in a web browser or other container for the presentation of web content, such as a WebView or UIWebView class. Accordingly, the customer application 316 may include dynamic scripting or programmatic elements described using any programming language, such as JavaScript™, ActiveScript™, VBScript™, Perl™, and so forth. Implementations support the use of any appropriate web browser to execute the customer application 316. Such a web browser may include, but is not limited to, one or more of the following: Mozilla Firefox™; Microsoft Internet Explorer™; Google Chrome™; Apple Safari™; Rockmelt™; and so forth. In cases where the customer application 316 is configured to be presented, at least partly, within a web browser or other container for the presentation of web content, the customer application 316 may include any number of web pages that are described at least in part using a markup language such as any version of Hypertext Markup Language (HTML), Dynamic HTML (DHTML), Extensible HTML (XHTML), Extensible Markup Language (XML), and so forth.

The customer application 316 may include a UI that enables the user 102 to interact with the customer application 316. The customer application 316 may be location sensitive and may present different information based on a current location of the mobile device 104. For example, if the mobile device 104 is currently in the laundromat, the customer application 316 may present a first set of UIs related to laundry loads in progress, additional service(s) that may be requested, available vending machines 302, games, advertisements, and surveys to pass the time, or other information.

The microcontroller 306 may cause the network interface(s) 308b to emit a signal 318. In some implementations, the signal 318 may be emitted within a particular frequency range such that a wireless network interface of the mobile device 104 is able to detect and receive the signal 318. In some implementations, the signal 318 may comply with a version of Bluetooth Low Energy™ or Bluetooth™, and the wireless network interface may be configured to receive and/or send signal that are compliant with a version of such protocols. The wireless network interface may also be configured to receive and send other suitable types of (e.g., radio frequency) communications. The signal 318 may be emitted periodically to indicate the presence of and/or or status information for the vending machine 302. Accordingly, the network interface(s) 304b may be component(s) of the signal 318. The signal 318 may include an identifier that identifies the particular vending machine 302 from which the signal 318 originates. In some cases, the identifier may uniquely identify the vending machine 302 among the plurality of vending machine 302 managed within system 300. In some cases, the identifier may uniquely identify the vending machine 302 among the plurality of vending machines 302 in a particular facility. The signal 318 may also include other information regarding the vending machine 302, such as the availability of the machine, the status (e.g., operational, non-operational, in use, idle, etc.) of the machine, metadata describing the machine (e.g., location, type, model, price, etc.), and so forth.

In some implementations, based on receiving an indication of the received signal 318, the customer application can determine that the mobile device 104 is within a threshold distance of the vending machine 302. This determination may be described as a bump of the mobile device 104 with vending machine 302. A bump may include physical contact between the mobile device 104 and a portion of the vending machine 302. In some cases, a bump can be detected if the mobile device 104 does not contact the vending machine 302 but is within the threshold distance of the vending machine 302, as indicated by the received signal level of the signal 318 being at least a threshold level.

In some cases, the user 102 may login to the customer application 316 by entering one or more credentials such as a user name, password, and so forth. In some cases, the user 102 may be authenticated by the management module(s) 124 based on credential(s). In some cases, the approval of requests by mobile device 104 may be further based on whether the user 102 has been authenticated as an authorized user of the service.

Vending machine electronic module 304 includes machine control module(s) 322 and machine display module(s) 324. Machine control module(s) 322 and machine display module(s) 324 can be included on circuit board 326. Machine control module(s) 322 are connected to user control panel 328. User control panel 328 may include buttons, a keypad, or other user input devices. Machine display module 324 is coupled to display panel 330. Display panel 330 can include LED indicators, an LCD display, touchscreen, or other display devices.

The machine control module(s) 322 can control and monitor operations or conditions of the vending machine 302. For example, for laundry machine, such operations or conditions can include one or more of: the power state (e.g., on or off) of the laundry machine; the cycle of the laundry machine, such as whether the machine is currently in a wash cycle, spin cycle, dry cycle, soak cycle, and so forth; the presence of detergent, or the addition of detergent to the laundry; whether the door(s) of the laundry machine are locked or unlocked; and so forth.

Circuit board 326 includes credit card read interface port 332. In this example, transceiver unit 112 is coupled to vending machine electronic module 304 by way of credit card reader interface port 332. In some implementations, transceiver unit 112 emulates card reader interface commands to simulate a credit card transaction (for example, to enable buttons on the vending machine to operate, to make a purchase).

In some implementations, credit card reader 334 is disconnected from credit card reader interface port 332 when transceiver unit 112 installed. In other implementations, credit card reader 334 remains connected to credit card reader interface port 332. In some implementations, credit card reader 334 and transceiver unit 112 are coupled to credit card reader interface port 332 in a daisy-chain arrangement.

In this example, transceiver unit 112 is coupled to the vending machine by way of a credit card reader interface. In other examples, the transceiver unit may be coupled in another manner, including but not limited to interface ports for other types of payment processing devices.

In certain implementations, microcontroller 306 interfaces with the vending machine electronic module 304 via a serial port such as a Universal Serial Bus (USB) connection, a parallel port, an Ethernet connection, a ribbon cable (e.g., multi-wire planar cable), or any other type of wired or wireless interface that enables the transfer of information between the microcontroller 306 and the vending machine electronic module 304. In some cases, the microcontroller 306 may interface with vending machine electronic module 304 using one or more of a general-purpose input/output (GPIO) connector, a universal asynchronous receiver/transmitter (UART), an inter-integrated circuit (i2c), or a serial peripheral interface (SPI).

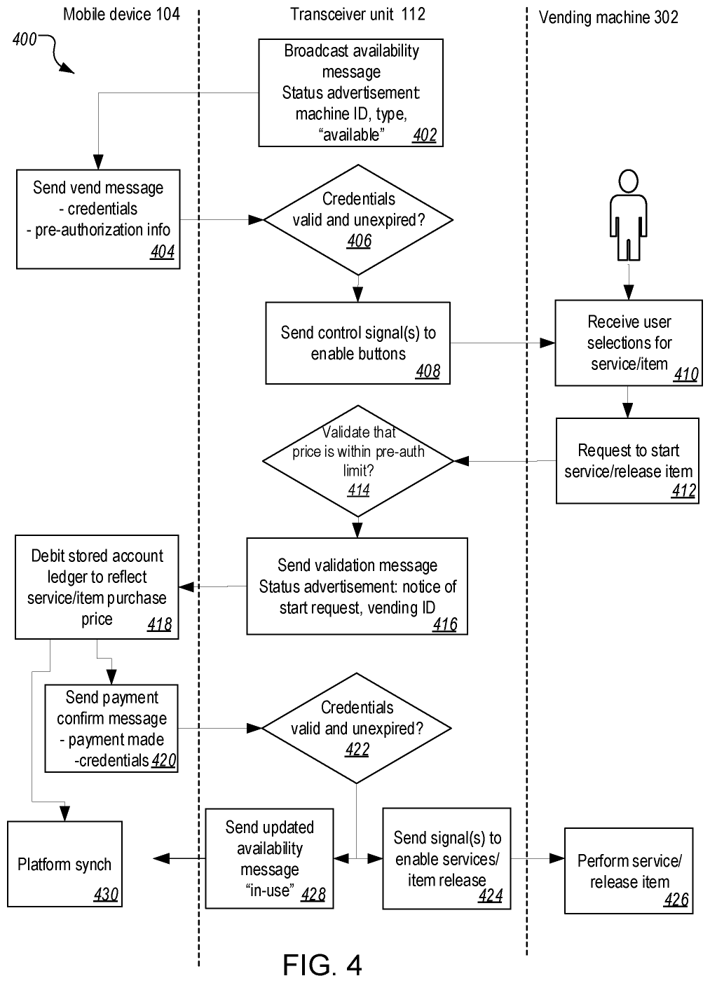

FIG. 4 depicts an example of a process for using a vending machine (e.g., a laundry machine or other unattended payment platform) that may be executed in accordance with implementations such as those of the present disclosure.

At the commencement of process 400, transceiver unit 112 broadcasts an availability message (402). The availability message is received by mobile device 104. For each vending machine 302 to which the transceiver unit 112 is coupled, the availability message includes the identity of the vending machine, the type of vending machine, and a status of the vending machine. Initially, status of the vending machine 302 is “available”.

The availability message and other messages from transceiver unit 112 may be in the form of a status advertisement. The status advertisement can provide status information about one or more vending machines 302. In some implementations, the status advertisement is sent periodically via BLE signal. For example, the status advertisement can include time remaining in a cycle. In some implementations, the status advertisement is sent about every 60 milliseconds.

User 102 may review the information from the availability message. If the vending machine is available, the user may decide to use the vending machine. If so, user 102 causes mobile device 104 to send a vend message to transceiver unit 112 (404). The vend message includes the pre-authorization information and credentials. In response to receiving the vend message, transceiver unit 112 makes a determination of whether credentials provided in the message are valid, unexpired, or both (406). If the credentials are valid and unexpired, transceiver unit 112 sends a signal to the vending machine to enable one or more user controls of the vending machine 302 and initiates a vend process (408). If the credentials are not valid or are expired, transceiver unit 112 can discontinue the process. Transceiver unit 112 can send a message to mobile device 104 indicating that the process has been terminated. In some implementations, the determination of whether to proceed is based at least in part on whether too much time has elapsed since the user last synchronized pre-authorization information (e.g., a stored value balance) with management platform server 108.

Once the buttons on laundry machine 106 are enabled, a user can make selections for operating the vending machine (410). The user may input the selections into a control panel on the vending machine. For example, in the case of laundry machine, the user may enter the time of the cycle, whether the cycle is heavy-duty, or other options. In the case of vending of an item (such as a food or beverage), the user may input a request to release the item. Vending machine 302 sends a signal indicating a request to start the vending machine or release the item from the vending machine (412).

In response to receiving the request to start the services or release the item, transceiver unit 112 determines whether the services that have been requested for start are within the pre-authorization limit (414). For example, if the user had a stored value balance of $28.00 and receives services with a purchase price of $6.00, the transceiver unit 112 will determine that there is a sufficient stored value balance and proceed with the transaction.

If the services that have been requested for start are not within the pre-authorization limit, the transceiver unit 112 declines to proceed with the transaction.

If the services/item that have been requested for start are within the pre-authorization limit, transceiver unit 112 sends a validation message with a vending ID identification to mobile device 104 (416). The validation message may be in the form of a status advertisement. The validation message can include the purchase amount for the requested transaction.

If the transceiver unit 112 has a network connection to management platform server 108, transceiver unit 112 informs management platform server 108 of the purchase.

In response to receiving the validation message, the mobile device 104 updates pre-authorization information to reflect the purchase price of the transaction (418). For example, if the user had a stored value balance of $28.00 and receives services with a purchase price of $6.00, the user's stored account balance on mobile device 104 can be updated to reflect a stored value balance of $22.00. The update to the stored value balance on the mobile device 104 can be performed whether or not the mobile device 104 has a network connection with management platform server 108.

Mobile device 104 sends a payment confirmation message to transceiver unit 112 (420). The payment confirmation message can indicate that the user's stored value balance has been or will be adjusted to reflect the price of the services to be performed by the vending machine and/or the price of the item to be released from the vending machine.

In response to receiving the vend message, transceiver unit 112 makes a determination of whether credentials provided in the message are valid and unexpired (422). If the credentials are valid and unexpired, transceiver unit 112 sends a message to vending machine 302 to cause vending machine 302 to perform the requested laundry services and/or release the item (424). In response to receiving the signal from transceiver unit 112, vending machine 302 performs the requested service and/or releases the requested item (426).

Transceiver unit 112 sends one or more updated availability messages to the mobile device 104 (428). For example, in the case of a laundry machine, transceiver unit 112 can provide a message to mobile device 104 indicating that the cycle on the selected laundry machine is in-process. Once vending machine 302 has performed the services, transceiver unit 112 can send a vend complete message to mobile device 104.

Mobile device 104 can send a message to management platform server 108 that a payment has been approved. In some cases, mobile device 104 is offline at the time of the transaction. When mobile device 104 has a network connection with management platform server 108, the stored value balance can be synchronized so that management platform server 108 such the ledger entries are updated such the server reflects the proper stored value balance (430).

In cases where a pre-authorization of a transaction expires (e.g., because the user has walked away from the machine), the pre-authorization amount will be released, making the amount available for another vending machine.

In the example describe above with respect to process 400, the payment is made based on the user having a stored value account. Other forms of payment can, in various implementations, be used for vending processes. For example, payment for a transaction can be made by way of a credit card, campus card, or peer-to-peer payment (e.g.,

Venmo^{TM}). In some implementations, all cycles for a given service experience (e.g., laundry experience) are aggregated into a cycle payment transaction. The payment can occur at a designated time later in the day (for example, 2:00 am on the morning after the transaction is carried out).

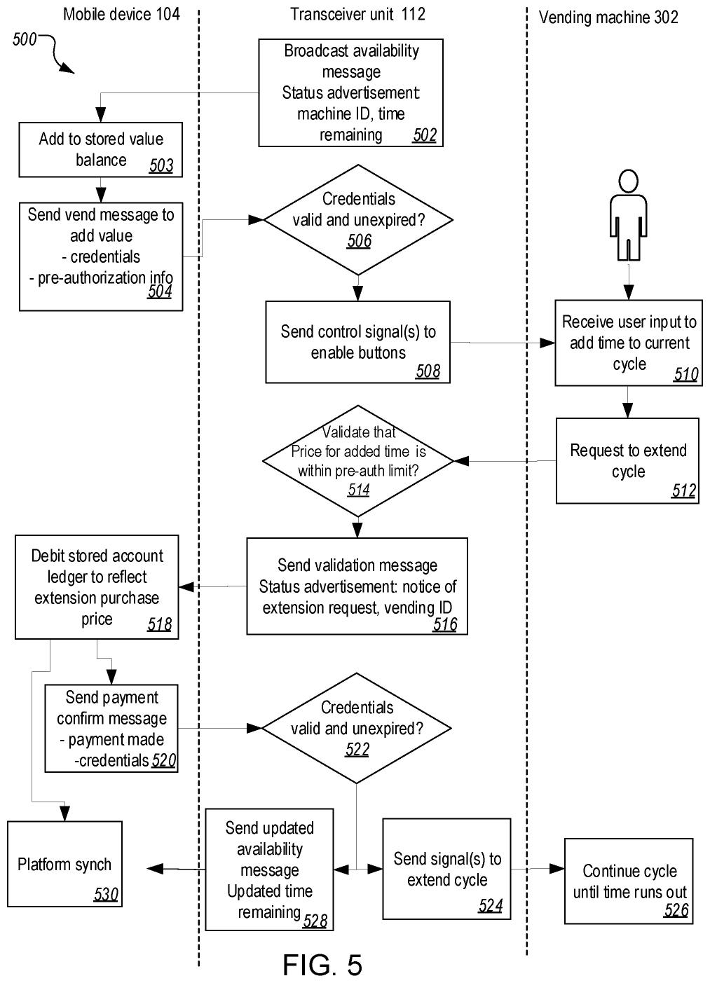

FIG. 5 depicts an example of extending a previously started vend process that may be executed in accordance with implementations such as those of the present disclosure. In this example, at the start of process 500, a service has already been commenced (for example, in the manner described for process 400). Transceiver unit 112 broadcasts an availability message (502). The availability message may be in the form of a status advertisement. The availability message is received by mobile device 104. The availability message includes the identity of the vending machine, the type of vending machine, and a status of the vending machine. In process 500, the status of the vending machine 302 can include, for example, a time remaining (for example, time remaining in a wash cycle of a car wash).

User 102 may review the information from the availability message. If the user wishes to extend the time for using the vending machine, user 102 can determine whether or not the user needs to add to the user's stored value balance before requesting additional time. If so, the user operates the mobile device 104 to add value to the user's stored balance (503). In some cases, the user may still have a sufficient stored value balance to extend the time without adding to the user's stored balance account. In either case, user 102 can cause mobile device 104 to send a vend message to transceiver unit 112 (504). If the user has added to the stored value balance, the updated stored value balance can be sent to transceiver unit 112 in the vend message.

In response to receiving the vend message, transceiver unit 112 makes a determination of whether credentials provided in the message are valid and unexpired and makes any required update to the stored value balance (506). If the credentials are valid and unexpired, transceiver unit 112 sends a signal to the vending machine to enable one or more user controls of the vending machine 302 (508).

Once the buttons on laundry machine 106 are enabled, a user can make selections to add time to the vending machine (510). The user may input the selections into a control panel on the vending machine. Vending machine 302 sends a signal indicating a request to add time to the current cycle (512).

In response to receiving the request to extend the transaction, transceiver unit 112 determines whether the additional services that have been requested (e.g., more time) are within the pre-authorization limit (514). If the additional services that have been requested for start are not within the pre-authorization limit, the transceiver unit 112 decline to make the addition of time.

If the extension of services that has been requested are within the pre-authorization limit, transceiver unit 112 sends a validation message with a vending ID identification to mobile device 104 (516). The validation message may be in the form of a status advertisement. The validation message can include the purchase amount for the requested extension.

In response to receiving the validation message, the mobile device 104 updates pre-authorization information to reflect the purchase price of the extension (e.g., added time) (518). The update to the stored value balance on the mobile device 104 can be performed whether or not the mobile device 104 has a network connection with management platform server 108.

Mobile device 104 sends a payment confirmation message to transceiver unit 112 (520). The payment confirmation message can indicate that the user's stored value balance has been or will be adjusted to reflect the price of the extension of services.

In response to receiving the vend message, transceiver unit 112 makes a determination of whether credentials provided in the message are valid and unexpired (522). If the credentials are valid and unexpired, transceiver unit 112 sends a message to vending machine 302 to cause vending machine 302 to continue the cycle for the requested additional time (524). In response to receiving the signal from transceiver unit 112, vending machine 302 performs the requested extension (526).

Transceiver unit 112 sends one or more updated availability messages to the mobile device 104 (528). The updated availability message can include an update to the time remaining in the cycle.

When mobile device 104 has a network connection with management platform server 108, the stored value balance can be synchronized so that management platform server 108 reflects the proper stored account balance (530).

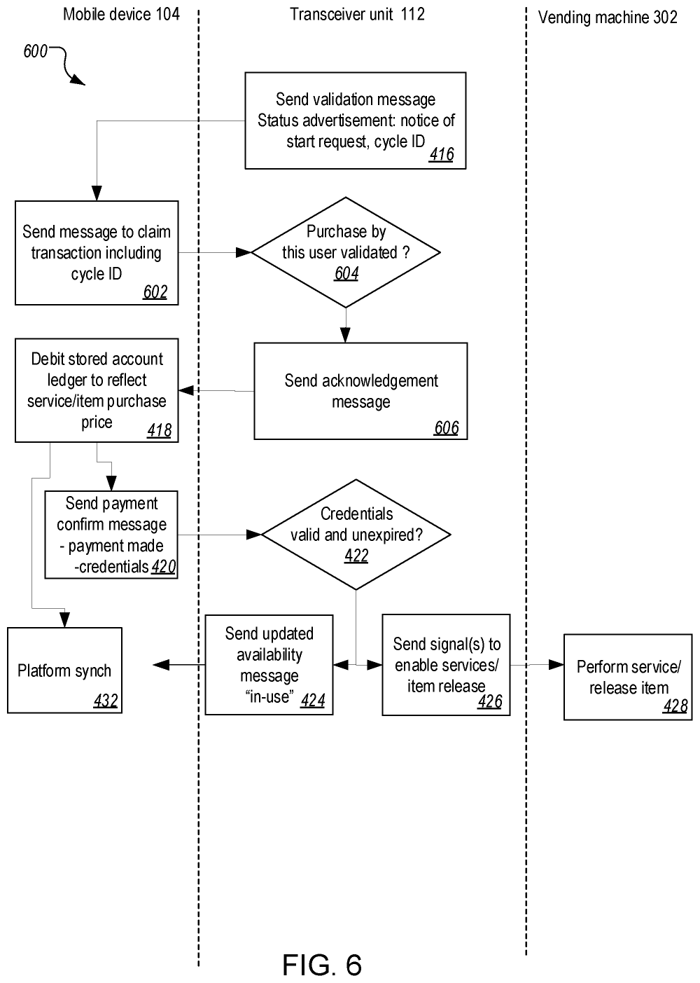

FIG. 6 depicts an example of vend process 600 that includes a mobile device claiming a vending machine service by providing a cycle ID. Process 600 can be integrated in to the steps of process 400, described above. In the same manner as described above relative to FIG. 4, transceiver unit 112 broadcasts a validation message (416). The validation message includes a cycle ID generated by transceiver unit 112.

In response to receiving the validation message, mobile device 104 sends a message to claim the transaction (602). The message can be sent via BLE signal. Receipt of the message by transceiver unit 112 provides an indication that the mobile device 104 is in range of transceiver unit 112. The message from mobile device 104 can include a request for specification information (for example, to request cycle ID, how much spent). Messages exchanged between mobile device 104 and transceiver unit 112 can include the cycle ID from the validation message. The cycle ID is communicated via BLE characteristics. The initiation of the message includes creating a session including a session ID. The transceiver unit 112 determines the identity of the mobile device 104 based on the session ID. A session ID can be created periodically (e.g., every 0.5 seconds) to replace the certificate.

In response to receiving the message from mobile device 104 to claim the transaction, transceiver unit 112 validates the purchase by the user (604). If validated, transceiver unit 112 send an acknowledgment message to mobile device 104 (606).

In one implementation, the availability message is a BLE status advertisement includes an eight character message includes two or more characters representing the identity of the vending machine, one character representing the type of the vending machine, and one character representing the status of the machine. An example of such a message is as follows: 505wa, where machine ID is 505, type: washer (w), dryer (d); state:

available (a) in-cycle (i).

In response to receiving the acknowledgement message, mobile device 104 debits the stored account ledger to reflect the purchase price (418) and sends a payment confirmation message to transceiver unit 112. The transaction can proceed as previously described for process 400 relative to FIG. 4.

In some implementations, the system uses encryption (e.g., PKI encryption) to secure communications between mobile device 104 and transceiver unit 112 during a transaction.

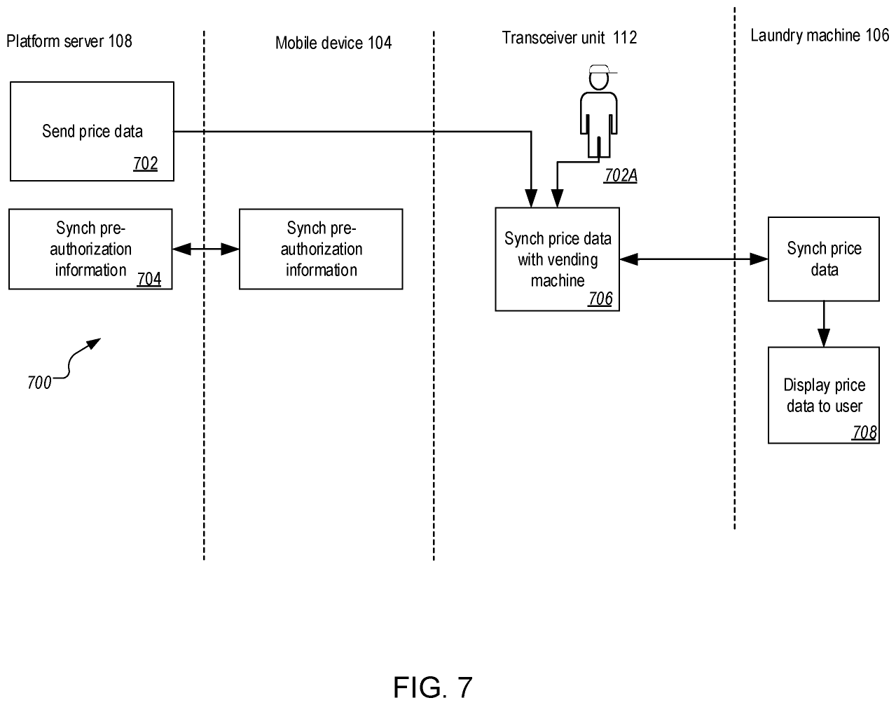

FIG. 7 depicts an example of a process 700 including pre-transaction transfer of payment and pricing information from a management platform server that may be executed in accordance with implementations such as those of the present disclosure. In some implementations, the system allows for dynamic pricing of services. For illustrative purposes, dynamic pricing for laundry services is described. Dynamic pricing can, nevertheless, in various implementations, be provided for other services and products.

Management module(s) 124 may collect data regarding the operations of the laundry service. Such data may include, but is not limited to: current usage data describing the current usage (or non-usage) of the laundry machines 106 managed by the laundry service; reservation data describing the current reservations of laundry machine(s) 106; historical data describing the past usage and reservations of laundry machine(s) 106; or user population data describing the number, locations, distribution, density, or other characteristics of the users 102 currently registered as customers of the laundry service.

The management module(s) 124 can analyze the data collected and dynamically determine pricing of laundry services based on the data analysis. The laundry service may charge a price to the user 102 for the use of a washer, dryer, other laundry machine(s) 106, or for the additional service(s).

In some implementations, the pricing may be dynamically modifiable based on various considerations. For example, if particular laundromat(s), or the laundry service generally, is exhibiting an increase in usage during a particular time of day, day of the week, day of the year, and so forth, the price of laundry service(s) (e.g., washing, drying, etc.) may be decreased or increased during such times. Moreover, if a particular laundromat is being underutilized, the price of services at that laundromat may be lowered to encourage more customers to try the laundry service. In some cases, if a particular laundromat is experiencing high usage compared to other laundromats in the area, prices at the high-usage laundromat may be increased or prices at the lower-usage laundromats may be decreased to encourage customers to use other laundromats. Moreover, prices at one or more laundromats may be lowered as part of a sale, promotion, or other marketing strategy to encourage customers to use the laundry service. In some cases, lower prices may be charged at a new laundromat, during a period of time following the opening of the new laundromat, to introduce the laundry service to new customers. In some cases, the laundry service may monitor laundry machine(s) 106 to detect instances in which laundry is left in a machine after a cycle or operation time period has completed, and a user 102 may be charged for the time when the laundry is blocking others from using the machine. Such charges, as well as any other charges for laundry services, may be dynamically adjusted.

In some implementations, pricing can be based on one or more of the following: tender-type, day of week, time of day, or stored value balance for the user.

Price data is sent from platform server 108 to transceiver unit 112 (702). Price data can also be transferred to transceiver unit 112 by an operator at the location of transceiver unit 112 (using, for example, a route operator tool) (702A).

Transceiver unit 112 synchronizes price data with laundry machine 106. The synchronized data can be displayed to a user of laundry machine 106. In some implementations, transceiver unit 112 overrides price information contained on laundry machine 106, such that the display on the laundry machine 106 reflects the dynamic pricing information provided to transceiver unit 112 instead of price information that was previously stored on laundry machine 106. Transceiver unit 112 can update the price displayed on laundry machine 106 at any time (before, during, or after a transaction).

Pre-authorization information of the user of mobile device 104 is synchronized between management platform server 108 and mobile device 104. The pre-authorization information can be used by the mobile device 104 to authorize transactions by the account holder even when mobile device 104 does not have a network connection. Pre-authorization can be on a per user basis.

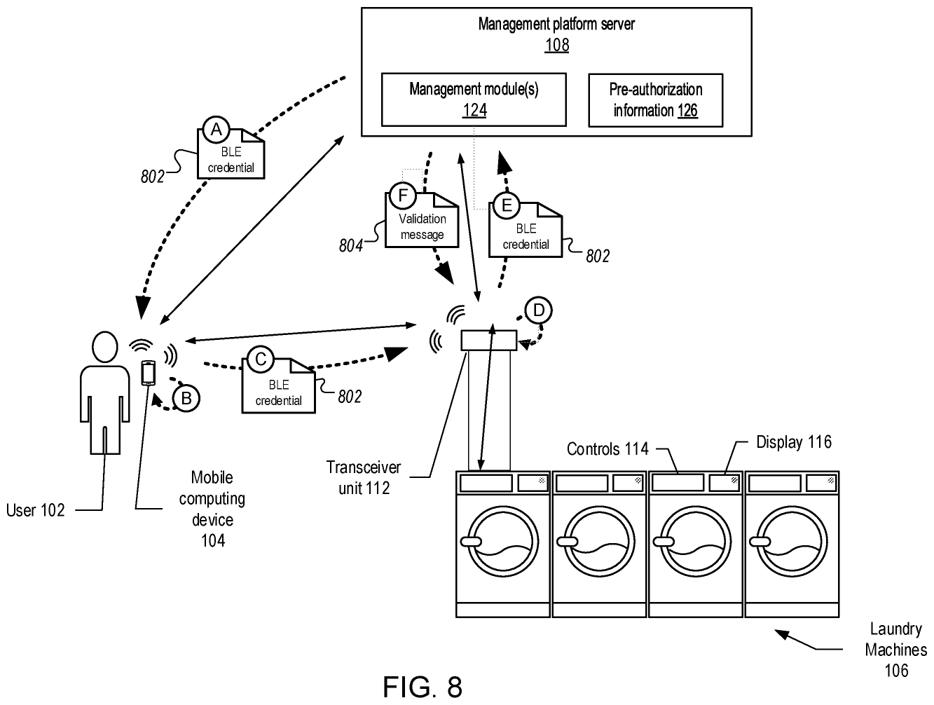

FIG. 8 depicts an example of a process 800 for validating credentials for a transaction from a vending machine that can be executed in accordance with implementations such as those of the present disclosure. In some implementations, application 316 (described above relative to FIG. 3) has an access control credential and a BLE payment credential. The BLE payment credential may expire frequently. The BLE payment credential can also be revoked prior to expiration. The BLE payment credential can be frequently updated on mobile device 104.

During state (A), BLE credential 802 is sent to mobile device 104. During state (B), application 316 stores BLE credential 802 in a secure element. During state (C), in order to enable a transaction from a vending machine, mobile device 104 sends BLE credential 802 to transceiver unit 112. During state (D), transceiver unit 112 confirms that BLE credential 802 is a valid credential and is non-expired. Transceiver unit 112 can validate BLE credential with a public key stored within transceiver unit 112.

In cases where transceiver unit 112 has a network connection to management platform server 108, during state (E), transceiver unit 112 can send BLE credential 802 to management platform server 108 to check on whether BLE credential 802 has been revoked. During state (F), management platform server 108 sends a validation message 804 indicating the whether BLE credential 802 has been revoked.

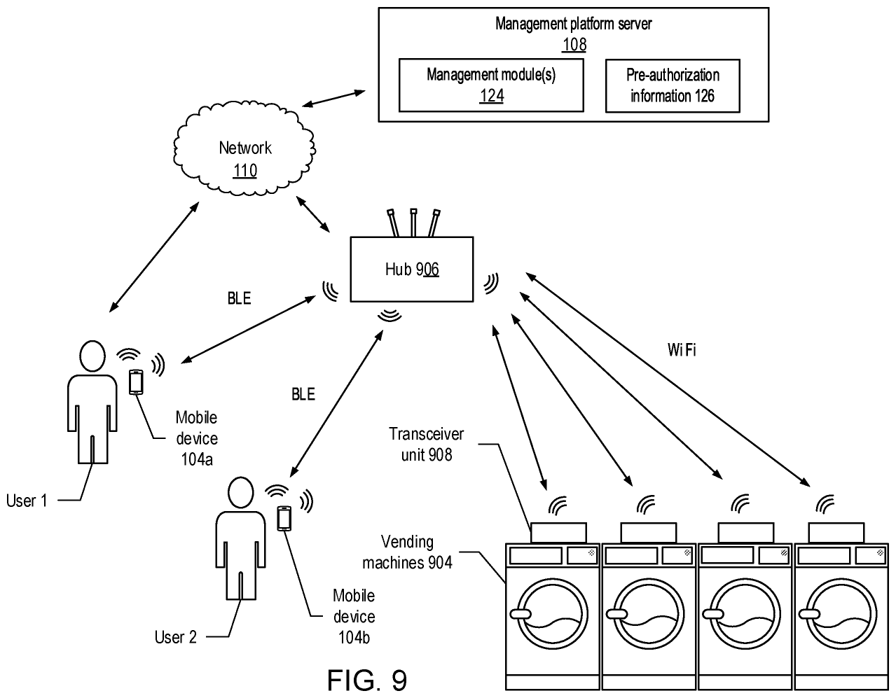

FIG. 9 depicts an example of a system including a hub for conveying signals between mobile devices and vending machines. Mobile devices 104A of User 1 and 104B of User 2 are connected to vending machines 904 by way of hub 906. Hub 906 exchanges signals with mobile devices 104 by way of a BLE connection. Hub 906 exchanges signals with mobile devices 104 by way of a Wi-Fi connection via transceiver unit 908. Vending machines 904 notify hub 906 of the status of the vending machines. Hub 906 maintains a list available vending machines 904.

When a user wishes to receive services from one of vending machines 904, the user operates mobile device 104 to request a list of available machines 904 from hub 906. Hub 906 notifies mobile device 104 of the available vending machines 904. Hub 906 receives and processes requests to vend from mobile device 104 to provide services. In some implementations, hub 906 performs the steps described in FIG. 3 to approve and enable transactions based on pre-authorization information received from mobile devices 104.

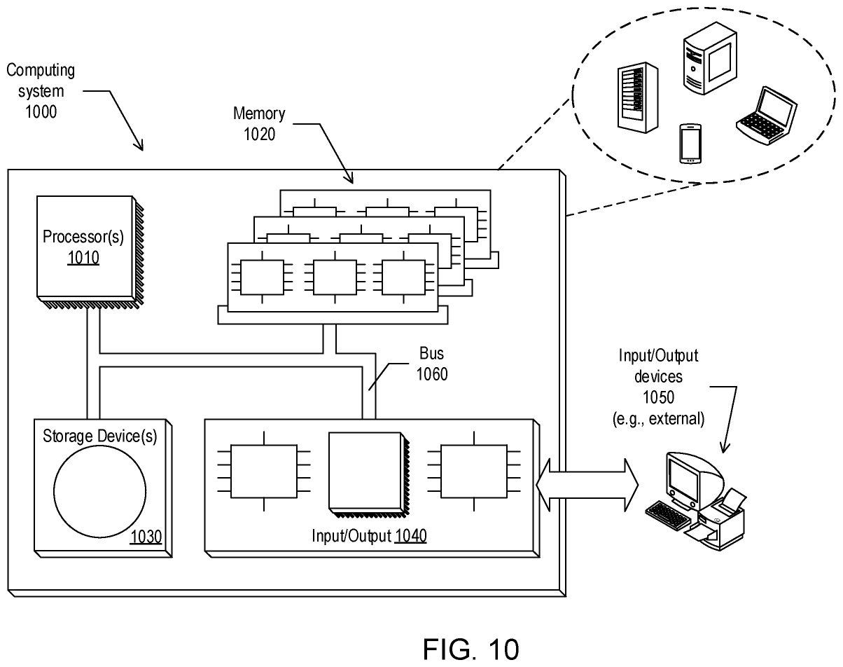

FIG. 10 depicts an example computing system 1000 in accordance with implementations such as those of the present disclosure. The system 1000 may be used for any of the operations described with respect to the various implementations discussed herein. For example, the system 1000 may be included, at least in part, in one or more of the mobile device 104, other user device(s), the management platform server 108, or the microcontroller 306 described herein. The system 1000 may include one or more processors 1010, a memory 1020, one or more storage devices 1030, and one or more input/output (I/O) devices 1050 controllable via one or more I/O interfaces 1040. Two or more of the components 1010, 1020, 1030, 1040, or 1050 may be interconnected via at least one system bus 1060, which may enable the transfer of data between the various modules and components of the system 1000.

The processor(s) 1010 may be configured to process instructions for execution within the system 1000. The processor(s) 1010 may include single-threaded processor(s), multi-threaded processor(s), or both. The processor(s) 1010 may be configured to process instructions stored in the memory 1020 or on the storage device(s) 1030. The processor(s) 1010 may include hardware-based processor(s) each including one or more cores. The processor(s) 1010 may include general purpose processor(s), special purpose processor(s), or both.

The memory 1020 may store information within the system 1000. In some implementations, the memory 1020 includes one or more computer-readable media. The memory 1020 may include any number of volatile memory units, any number of non-volatile memory units, or both volatile and non-volatile memory units. The memory 1020 may include read-only memory, random access memory, or both. In some cases, the memory 1020 may be employed as active or physical memory by one or more executing software modules.

The storage device(s) 1030 may be configured to provide (e.g., persistent) mass storage for the system 1000. In some implementations, the storage device(s) 1030 may include one or more computer-readable media. For example, the storage device(s) 1030 may include a floppy disk device, a hard disk device, an optical disk device, or a tape device. The storage device(s) 1030 may include read-only memory, random access memory, or both. The storage device(s) 1030 may include one or more of an internal hard drive, an external hard drive, or a removable drive.

One or both of the memory 1020 or the storage device(s) 1030 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 1000. In some implementations, the CRSM may include a data store that provides storage of computer-readable instructions or other information in a non-transitory format. The CRSM may be incorporated into the system 1000 or may be external with respect to the system 1000. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some cases, the processor(s) 1010 and the memory 1020 may be supplemented by, or incorporated into, one or more application-specific integrated circuits (ASICs).

The system 1000 may include one or more I/O devices 1050. The I/O device(s) 1050 may include one or more input devices such as a keyboard, a mouse, a pen, a game controller, a touch input device, an audio input device (e.g., a microphone), a gestural input device, a haptic input device, an image or video capture device (e.g., a camera), or other devices. In some cases, the I/O device(s) 1050 may also include one or more output devices such as a display, LED(s), an audio output device (e.g., a speaker), a printer, a haptic output device, and so forth. The I/O device(s) 1050 may be physically incorporated in one or more computing devices of the system 1000, or may be external with respect to one or more computing devices of the system 1000.

The system 1000 may include one or more I/O interfaces 1040 to enable components or modules of the system 1000 to control, interface with, or otherwise communicate with the I/O device(s) 1050. The I/O interface(s) 1040 may enable information to be transferred in or out of the system 1000, or between components of the system 1000, through serial communication, parallel communication, or other types of communication. For example, the I/O interface(s) 1040 may comply with a version of the RS-232 standard for serial ports, or with a version of the IEEE 1284 standard for parallel ports. As another example, the I/O interface(s) 1040 may be configured to provide a connection over Universal Serial Bus (USB) or Ethernet. In some cases, the I/O interface(s) 1040 may be configured to provide a serial connection that is compliant with a version of the IEEE 1394 standard.

The I/O interface(s) 1040 may also include one or more network interfaces that enable communications between computing devices in the system 1000, or between the system 1000 and other network-connected computing systems. Such network interface(s) may include network interface(s) 308a and 308b. The network interface(s) may include one or more network interface controllers (NICs) or other types of transceiver devices configured to send and receive communications over one or more networks, such as the network(s) 110, using any network protocol.

Computing devices of the system 1000 may communicate with one another, or with other computing devices, using one or more networks such as the network(s) 110. Such networks may include public networks such as the internet, private networks such as an institutional or personal intranet, or any combination of private and public networks.

The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 1000, such as the mobile device 104, the management server 108, or the microcontroller 306, may include any number of computing devices of any type.

The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a SoC, a SiP, and so forth.

Although examples herein may describe computing device(s) as physical device(s), implementations are not so limited. In some cases, a computing device may include one or more of a virtual computing environment, a hypervisor, an emulation, or a virtual machine executing on one or more physical computing devices. In some cases, two or more computing devices may include a cluster, cloud, farm, or other grouping of multiple devices that coordinate operations to provide load balancing, failover support, parallel processing capabilities, shared storage resources, shared networking capabilities, or other aspects.

The features described may be implemented in digital electronic circuitry or in computer hardware, software, or any combinations of hardware and software. The features may be implemented in at least one computer program product that is tangibly embodied in an information carrier (e.g., a machine-readable storage device) for execution by a programmable processor. The method or process steps may be performed by a programmable processor executing instructions to perform functions of the described implementations by operating on input data and generating output. The described features may be implemented in one or more computer programs that are executable on a programmable system including at least one programmable processor coupled to receive data and instructions from, and to transmit data and instructions to, a data storage system, at least one input device, and at least one output device. A computer program may include a set of instructions that can be used, directly or indirectly, in a computer to perform a certain activity or bring about a certain result. A computer program may be written in any form of programming language, including compiled or interpreted languages, and it may be deployed in any form, including as a stand-alone program or as a module suitable for use in a computing environment.

As used herein, vending may describe enabling a device to provide products or service.

As used herein, a vending machine may describe a machine from which products or services can be vended. Examples of vending machines include laundry machines (washers or dryers), snack machines, ticket kiosks, car wash kiosks, retail kiosks, and parking access or permission devices.

As used herein, a user may describe an individual person or multiple people.

As used herein, a signal may describe a wireless signal that is transmitted via electromagnetic (EM) waves of any type, including but not limited to a radio frequency signal, an infrared frequency signal, a microwave frequency signal, or a signal having a frequency in the visible portion of the EM spectrum. A signal may also be transmitted via sound waves, pressure waves, or via any other wireless mechanism. A signal may also describe an electrical signal, or other type of signal, that is transmitted over one or more wires.

As used herein, payment may describe the transfer of value from one party to another party. Such value may be described in units of any type of currency. Payment may also describe a transfer of any type of goods or services from one party to another party, as in a payment-in-kind, trade, service exchange, or barter arrangement. Payment may include the present (e.g., substantially immediate) transfer of value between parties.

Payment may also include a promise of value to be transferred in the future, or the rescinding of a previously made promise to transfer value.

As used herein, a laundry machine may describe any type of apparatus associated with the washing, drying, or other handling of laundry. Although examples herein may describe a laundry machine as a washer or a dryer, implementations are not so limited. Laundry machines may also include, but are not limited to, pressing or ironing apparatuses, dry cleaning machines, steam cleaning machines, laundry folding machines, fumigation machines, and so forth. Laundry machines may also include any type of apparatus or object that facilitates manual handling of laundry, such as wash basins or washboards to manually wash laundry, clotheslines, racks, hooks, or rods to manually hang laundry to dry, ironing boards or irons to press laundry, and so forth. Laundry machines may also include vending machines that dispense (e.g., for free or for a charge) items used in doing laundry, such as detergent, fabric softeners, stain removers, bleach, detergent additives, and so forth.

As used herein, doing laundry may describe using a laundry machine to process laundry in any way. For example, and without limitation, doing laundry may include using a washer to wash laundry or using a dryer to dry laundry.

As used herein, a laundromat may describe any facility that includes any number of laundry machines. A laundromat may be housed in a building or any portion of a building, and may include any number of rooms that are at least partly enclosed. A laundromat may also be an area of any size that includes any number of laundry machines in an indoor or outdoor environment.

As used herein, a module may describe software, such as firmware, that is executable on at least one computing device. A module may include any number of applications, processes, programs, libraries, interfaces, threads, application programming interfaces (APIs), scripts, batch files, classes, objects, executable files, routines, subroutines, firmware modules, or other types of executable software.

The logic flows depicted in the figures do not require the particular order shown, or any particular sequential order, to achieve desirable results. In some implementations, other steps may be provided or steps may be eliminated from the described flows. Moreover, the steps may be performed in parallel or serially with respect to other steps. The systems depicted in the figures do not require the particular components, or the particular arrangement of components, shown in the figures. In some implementations, the various systems may include more or fewer components than shown in the figures, and components may be arranged differently to achieve desirable results.

Accordingly, implementations other than those explicitly depicted in the figures or described herein are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method performed by a transceiver unit coupled to a vending machine, the method comprising:
broadcasting an availability message indicating an identity of the vending machine, a type of the vending machine, and a status of the vending machine;
receiving, from a mobile computing device, by way of one or more wireless signals, a vend message comprising pre-authorization information and a certificate indicating a time period since the certificate was synchronized with a server;
sending a signal to the vending machine to enable one or more user controls of the vending machine and initiate a vend process;
receiving a request from the vending machine to provide a service or product;
determining whether to approve a transaction based on the pre-authorization information;
sending a validation message and a vending identification to the mobile computing device, wherein the vending identification is usable by the mobile computing device to secure future communications between the transceiver unit and the mobile computing device until completion of the vend process; and
sending an updated availability message indicating the status of the vending machine as being in use.

2. The computer-implemented method of claim 1, wherein the vend message is received via a Bluetooth Low Energy (BLE) signal.

3. The computer-implemented method of claim 1, further comprising:
sending, to the mobile computing device, a purchase price for the transaction, and modifying, by the mobile computing device, the pre-authorization information to account for the purchase price for the transaction.

4. The computer-implemented method of claim 1, wherein:
the pre-authorization information comprises a pre-authorization amount, and determining whether to approve the transaction comprises determining whether a purchase price for the transaction is within the pre-authorization amount.

5. The computer-implemented method of claim 1, wherein determining whether to approve the transaction comprises determining that the certificate is valid.

6. The computer-implemented method of claim 2, wherein determining that the certificate is valid comprises determining that the time period is less than a validation time period.

7. The computer-implemented method of claim 1, wherein the pre-authorization information comprises a stored value balance.

8. The computer-implemented method of claim 1, wherein:
the pre-authorization information comprises a stored value balance received by the mobile computing device from a server over a network, and
the vend message is received while the mobile computing device is not connected to the server.

9. The computer-implemented method of claim 1, wherein the pre-authorization information comprises a tender type.

10. The computer-implemented method of claim 1, wherein sending the signal to the vending machine to enable one or more user controls of the vending machine comprises emulating a signal of a payment processing device.

11. The computer-implemented method of claim 1, wherein sending the signal to the vending machine to enable one or more user controls of the vending machine comprises emulating a signal of a credit card reader.

12. The computer-implemented method of claim 1, further comprising:
receiving, from the mobile computing device, a request for status information about the vending machine, the request comprising a session identifier derived from the vending identification, and
sending, to the mobile computing device, in response to the request, status information about the vending machine.

13. The computer-implemented method of claim 12, wherein the status information comprises time remaining of an operation of the vending machine.

14. The computer-implemented method of claim 12, wherein the status information comprises availability of the vending machine.

15. The computer-implemented method of claim 1, further comprising storing, in a memory, dynamic pricing information for transactions to be fulfilled by the vending machine, and
determining, based on the dynamic pricing information, a purchase price for at least one transaction to be fulfilled by the vending machine.

16. The computer-implemented method of claim 1, wherein the vending machine comprises a laundry machine.

17. The computer-implemented method of claim 1, wherein the pre-authorization information allows aggregation of payment for two or more transactions to be performed by one of the vending machine.

18. The computer-implemented method of claim 1, wherein the vend message is received via a Bluetooth Low Energy (BLE) signal via a hub coupled to two or more mobile computing devices or two or more vending machines.

19. The computer-implemented method of claim 1, wherein the availability message is an eight character message comprising two or more characters representing the identity of the vending machine, one character representing the type of the vending machine, and one character representing the status of the vending machine.

20. A computer-implemented method performed by at least one processor of a mobile computing device, the method comprising:
receiving, from a transceiver coupled to a vending machine, an availability message indicating an identity of the vending machine, a type of the vending machine, and a status of the vending machine;
in response to receiving user input requesting to initiate a vending transaction with the vending machine, sending, by way of one or more wireless signals to the transceiver, a vend message including the pre-authorization information and a certificate indicating a time period since the certificate was synchronized with a server;
receiving a validation message from the transceiver indicating a purchase price for the vending transaction;
sending a payment confirmation message to the transceiver;
updating the pre-authorization information based on the purchase price of the vend transaction.
